(19) United States
(12) Patent Application Publication
(10) Pub. No.: US 2025/0105401 A1
(43) Pub. Date: Mar. 27, 2025

(54) MANUFACTURING PROCESS FOR PRISMATIC BATTERY CELL ENCLOSURES

(71) Applicant: GM GLOBAL TECHNOLOGY OPERATIONS LLC, Detroit, MI (US)

(72) Inventors: Lu HUANG, Troy, MI (US); Ziqiang Sheng, Troy, MI (US); Wei Wu, Troy, MI (US); Hui-ping Wang, Troy, MI (US); Liang Xi, Northville, MI (US); Wai Ping Gloria Tam, Troy, MI (US)

(21) Appl. No.: 18/472,367

(22) Filed: Sep. 22, 2023

(51) Int. Cl. H01M 50/103; H01M 50/119; H01M 50/15; H01M 50/169

(52) U.S. Cl. CPC H01M 50/103; H01M 50/119; H01M 50/15; H01M 50/169

(57) ABSTRACT

A method for manufacturing an enclosure includes designing a two dimensional (2D) blank corresponding to a three dimensional (3D) enclosure body; laying out N of the 2D blanks on a metal sheet, where N is an integer greater than one; separating the N 2D blanks from the metal sheet; at least one of bending, folding and/or flanging the N 2D blanks into the 3D enclosure body; and joining a plurality of sides of the 3D enclosure body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to methods for manufacturing enclosures for prismatic battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for manufacturing an enclosure includes designing a two dimensional (2D) blank corresponding to a three dimensional (3D) enclosure body; laying out N of the 2D blanks on a metal sheet, where N is an integer greater than one; separating the N 2D blanks from the metal sheet; at least one of bending, folding, and flanging the N 2D blanks into the 3D enclosure body; and joining a plurality of sides of the 3D enclosure body.

In other features, the method includes coating the metal sheet with an insulating layer. The N 2D blanks further include a lid. The method further includes arranging a battery cell stack in the 3D enclosure body; and folding the lid to cover an opening of the 3D enclosure body and joining at least one side of the lid to an opening in the 3D enclosure body.

In other features, the lid includes at least one of a first opening for a terminal and a second opening for a vent. The method includes, after joining the plurality of sides of the 3D enclosure body, arranging a battery cell stack in the 3D enclosure body. The method includes joining a lid to an opening of the 3D enclosure body.

In other features, the lid is joined to the 3D enclosure body using at least one of laser welding, crimping, and brazing using a braze wire. One of the plurality of sides or sides of the 3D enclosure body can be ironed and solid-state joined. One of the plurality of sides of the 3D enclosure body can be laser welded. One of the plurality of sides of the 3D enclosure body can be joined using at least one of laser welding, electron beam welding, brazing with a braze wire, and induction welding. At least one of the N 2D blanks includes first and second complementary flange portions that align, mate and are joined after the at least one of bending and forming.

In other features, at least one of the N 2D blanks includes a corner that is radiused to prevent holes after folding and joining. At least one of the N 2D blanks includes side portions that include a projection to prevent holes after folding and joining. The metal sheet is made of a material selected from a group consisting of steel, stainless steel, and aluminum.

A method for manufacturing an enclosure includes providing a two dimensional (2D) blank corresponding to a three dimensional (3D) enclosure body and a lid at least partially attached to the 3D enclosure body; at least one of bending, folding, and flanging the 2D blank into the 3D enclosure body; joining sides of the 3D enclosure body; arranging a battery cell stack in the 3D enclosure body; and joining at least one side of the lid to the 3D enclosure body.

In other features, the 2D blank includes an insulating layer. The lid includes at least one of a first opening for a terminal and a second opening for a vent. At least one side of the lid is joined to the 3D enclosure body using at least one of laser welding, crimping, and brazing using a braze wire. The 2D blank is made of a material selected from a group consisting of steel, stainless steel, and aluminum.

A method for manufacturing an enclosure includes providing a two dimensional (2D) blank corresponding to a three dimensional (3D) enclosure body; at least one of bending, folding, and flanging of the 2D blank into the 3D enclosure body into a die cavity; joining sides of the 3D enclosure body using ironing and solid-state joining; arranging a battery cell stack in the 3D enclosure body; and joining a lid to the 3D enclosure body.

In other features, the lid includes at least one of a first opening for a terminal and a second opening for a vent. At least one side of the lid is joined to the 3D enclosure body using at least one of laser welding, crimping, and brazing using a braze wire. The 2D blank is made of a material selected from a group consisting of steel, stainless steel, and aluminum and the 2D blank includes an insulating layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIG. 2A is a perspective view of an example of a prismatic battery cell;

FIG. 2B is a perspective view of an example of a prismatic battery cell with a pressure-based vent cap;

FIG. 3 is a perspective view of an example of a metal sheet providing a plurality of 2D blanks for fabricating 3D enclosures according to the present disclosure;

FIGS. 4A to 4C are perspective views of an example of the 2D blanks folded and joined into a 3D enclosure for a prismatic battery cell according to the present disclosure;

FIGS. 5A to 5C illustrate an example of folding and joining of a 3D enclosure for a prismatic battery cell using a 2-piece (body and lid) assembly according to the present disclosure;

FIGS. 6A to 6C illustrate an example of folding and joining a 3D enclosure for a prismatic battery cell using a 1-piece (body lid integral) assembly according to the present disclosure;

FIGS. 7 to 9 illustrate examples of bending/forming of the enclosure using a die and a punch according to the present disclosure;

FIG. 10 is a perspective view of an example of a 3D enclosure with gaps;

FIGS. 11 and 12 are plan views illustrating an example of a 2D blank including extra material such as radiused corners and/or projections according to the present disclosure;

FIGS. 13A to 13C are perspective views illustrating manufacturing of another enclosure using ironing and solid-state joining according to the present disclosure; and

FIGS. 14A to 14C are examples of methods for manufacturing a 3D enclosure for a battery cell using a 2D blank according to the present disclosure.

In the drawings, reference numbers may be reused to identify similar and/or identical elements.

### DETAILED DESCRIPTION

While prismatic battery cells according to the present disclosure are shown in the context of electric vehicles, the prismatic battery cells can be used in stationary applications and/or other applications.

To meet the needs for different EV applications, prismatic battery cell enclosures may be manufactured using different form factors (including different x-axis, y-axis and/or z-axis dimensions). In some applications, prismatic battery cell enclosures with high aspect ratios and/or using different materials are desired. These dimensional and material requirements impose significant challenges to the forming and joining processes such as forward or backwards extrusion that have previously been used to manufacture the enclosures.

Manufacturing methods according to the present disclosure fabricate the prismatic battery cell enclosures using a hybrid die forming and bending process followed by in-line or off-line joining. The manufacturing methods according to the present disclosure offer versatile solutions that are applicable for a wide range of dimensions and materials for manufacturing enclosures for prismatic cells at high production rates.

In some examples, 2D blanks are designed and laid out on a metal sheet. In some examples, the 2D blanks are nested to increase material usage efficiency and reduce waste. The 2D blanks are cut from the metal sheet (e.g., using a trim die or other method). The 2D blanks are bent or folded into a body. One flange or multiple flanges of the 2D blanks can be bent or folded simultaneously into a die cavity. The body is fixtured and welded. In some examples, the 2D blanks are a single-piece assembly that includes a lid that is folded and joined. In other examples, the 2D blanks are a two piece assembly and the lid is joined after the body is manufactured.

In some examples, joining includes laser welding edges of the enclosure. In some examples, a lid can be attached to an open body of the enclosure using crimping. In other examples, joining includes brazing using a braze wire, electron beam welding, induction welding, or other types of joining.

In other examples, the 2D blanks are designed, laid out on a metal sheet, and cut from the metal sheet. The 2D blanks are bent or folded into a body. One flange or multiple flanges of the 2D blanks can be bent or folded simultaneously into a die cavity. Ironing and solid-state joining are used to join edges of the body of the enclosure. In some examples, supplementary joining steps (e.g., lase welding) are optionally performed if needed. Trimming can optionally be performed to remove uneven edges if needed.

Referring now to FIG. 1, a battery cell 10 includes C cathode electrodes 20, A anode electrodes 40, and S separators 32 arranged in a predetermined sequence in a stack 12 located in an enclosure 50. The C cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46.

In some examples, the current collectors are made of one or more materials selected from a group consisting of copper, stainless steel, brass, bronze, zinc, aluminum, and/or alloys thereof. In some examples, external tabs connected to the current collectors of the anode electrodes and cathode electrodes are located on opposite sides of the battery stack (as shown in FIG. 1) or on the same side of the battery stack.

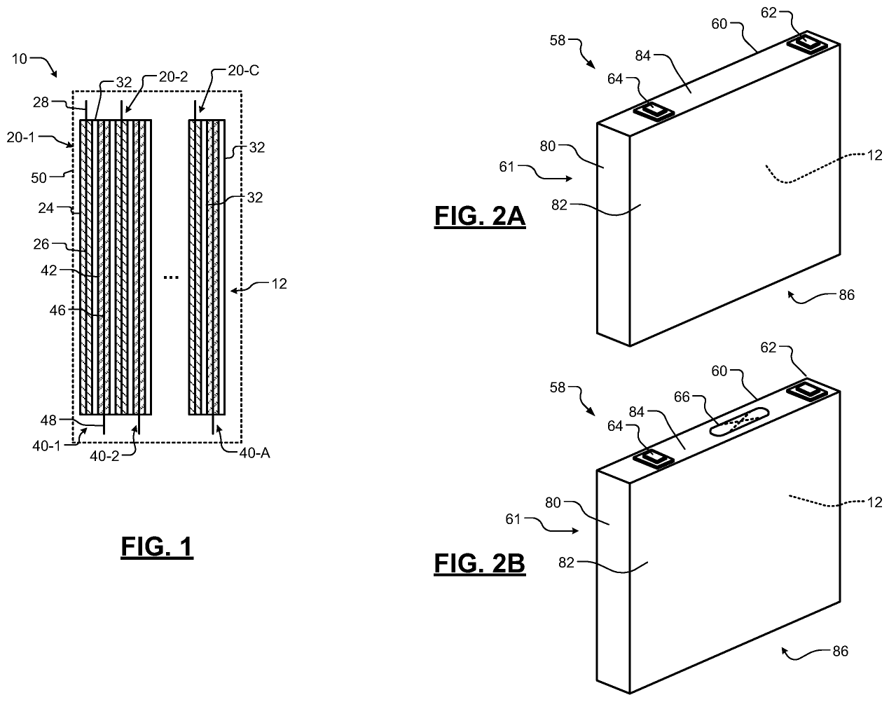

Referring now to FIGS. 2A and 2B, a prismatic battery cell 58 includes an enclosure 60. In some examples, the enclosure 60 has a prismatic shape (e.g., rectangular cross-sections in x-, y- and z-axis planes). The enclosure 60 includes a body 61 including sides 80 and sides 82 and a bottom portion 86 defining an open-ended prism. In some examples, the sides 80 have a narrower width than the sides 82

A lid portion 84 is attached to the body 61 to enclose a top opening of the body 61. The prismatic battery cell 58 includes external terminals 62 and 64 that pass through the lid portion 84. The stack 12 of the C cathode electrodes 20, the A anode electrodes 40, and the S separators 32 is arranged in the enclosure 60 before attaching the lid.

The external terminals 62 and 64 are connected to external tabs of the A anode electrodes 40 and the C cathode electrodes 20, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

As noted above, the method for manufacturing an enclosure for a prismatic battery cell according to the present disclosure includes various steps such as 2D blank design, 2D blanking, die bending/folding/flanging, ironing, in-line and/or off-line joining, and/or trimming. In some examples, the entirety or a major portion of the manufacturing process can be executed in a progressive feed line, similar to a progressive die stamping, to achieve high production rates.

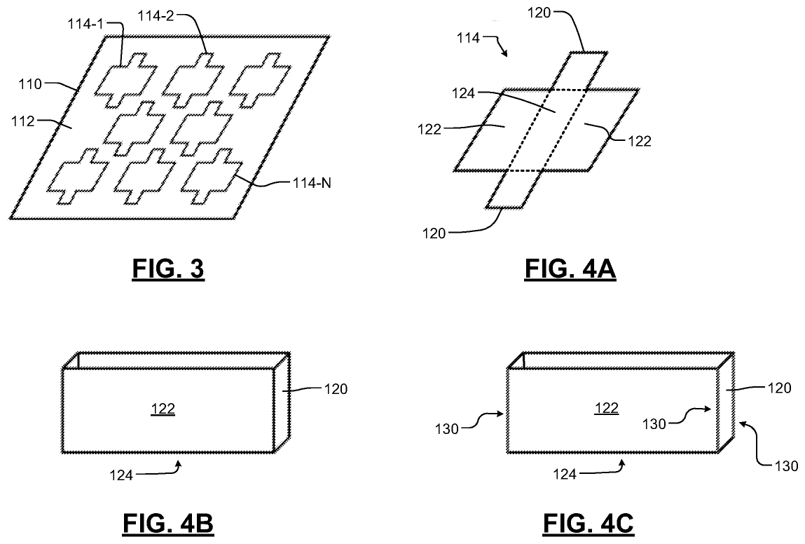

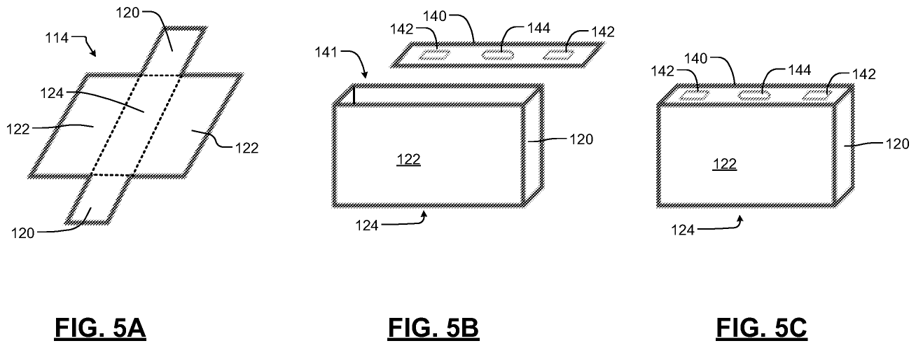

Referring now to FIGS. 3 to 4C, an example of a method for manufacturing the enclosure for a prismatic battery cell is shown. In FIG. 3, after determining the shape, one or more 2D blanks 114-1, 114-2, . . . , and 114-N (where N is an integer greater than one) are laid out on a metal sheet 110. In some examples, the metal sheet 110 may comprise steel, stainless steel, coated steel, aluminum, or other material. In some examples, the metal sheets 110 are coated with an optional insulating layer 112.

The 2D blanks 114 are designed with a 2 dimensional (2D) shape to accommodate bending, folding, ironing, joining, and/or trimming operations that follow. In other words, the 2D blanks are 2 dimensional (2D) patterns (in an unfolded state) that are bent, folded, flanged, and/or joined to form the 3D enclosure.

The 2D blanks 114 are separated from the metal sheet 110 as shown in FIG. 4A. In some examples, the 2D blanks 114 include first sides 120, second sides 122, and a bottom 124 that form an open body. In some examples, the 2D blanks 114 are sheared using a trim die or cut using other techniques such as laser cutting or waterjet cutting. Shearing/trimming offers a faster 2D blanking speed and is capable of yielding multiple pieces per cycle to further increase production rates. In FIG. 4B, one or more of the flanges 120 and 122 of the 2D blanks 114 are folded at the same time (e.g., along dotted lines) in a flanging die or a forming die and joined along edges thereof into an enclosure for a prismatic battery cell as shown in FIG. 4C.

In some examples, the 2D blank is punched into a die cavity and conforms to the shape of the die and punch. The bending/folding may include one or more steps such as cutting, flanging, and/or folding. One or more flanges can be folded at the same time. In addition to bending/folding/flanging, drawing, stretching, and/or compression can be performed and designed into the die forming process to achieve desirable features (offsets, sealed corners, etc.) in a separate step or simultaneously with bending/folding/flanging. For example, the 2D blank can be designed with excessive material at corners and/or projections along edges to eliminate bend reliefs/small holes at the corners and/or other locations that are typical in a press brake bending design.

Due to the low tonnage requirement to bend/fold/flange the materials, it becomes feasible to form multiple cans simultaneously using multi-cavity tooling to increase production rate. The flanges are joined to close the battery cell enclosure to achieve hermetic sealing and desirable joint strength.

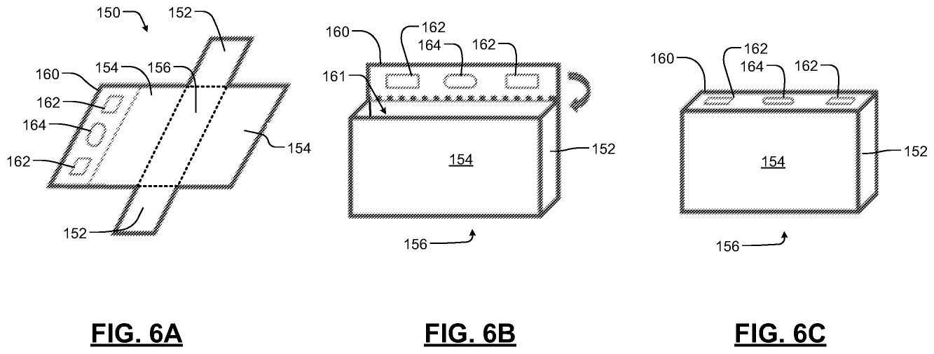

In some examples, an enclosure for a prismatic battery cell is folded and joined using a 2-piece assembly in FIGS. 5A to 5C and/or a 1-piece assembly in FIGS. 6A to 6C. In FIGS. 5A to 5C, after 2D blanking, folding, and joining, a lid 140 is attached to an opening 141 of the enclosure. In some examples, the lid 140 includes openings 142 for terminals and/or an opening 144 for a vent cap.

In FIGS. 6A to 6C, a 2D blank 150 further includes material for the lid. The 2D blanks 150 include first sides 152, second sides 154, a bottom 156, and a lid 160 connected to one of the second sides 154. After 2D blanking, folding, and joining, the lid 160 is folded along one edge and joined to an opening 161 of the enclosure. In some examples, the lid 160 includes openings 162 for terminals and/or an opening 164 for a vent cap.

In some examples, edges of the enclosure are joined using laser welding. In other examples, the lid can be attached to the body of the enclosure using crimping. In other examples, edges of the enclosure are joined by brazing using a braze wire, electron beam welding, induction welding, or other types of joining.

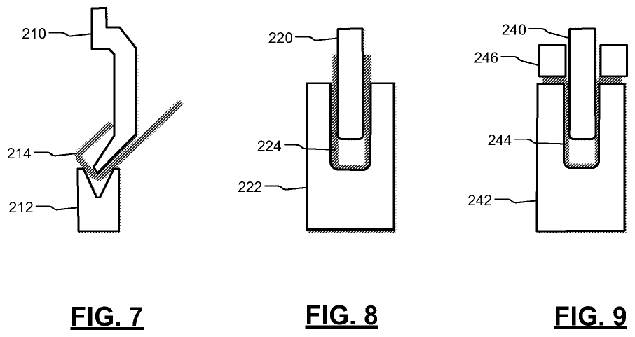

Referring now to FIGS. 7 to 9, the enclosure can be flanged, bent, or folded using a die, a punch, and/or a clamp. In FIG. 7, a press brake (not shown), a die 212, and a punch 210 are used to flange, bend, and/or fold a 2D blank 214. In FIG. 8, die bending and folding are performed on a 2D blank 224 using a punch 220 and a die 222 without clamping. In FIG. 9, a punch 240, a die 242, and a clamp 246 are used to form the 2D blank.

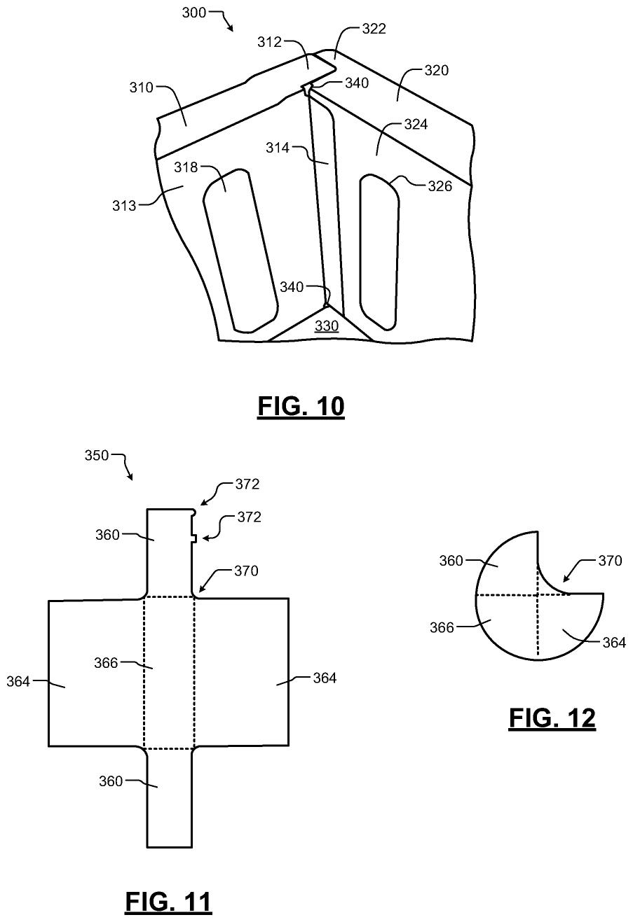

Referring now to FIGS. 10 to 12, in addition to bending/folding/joining, drawing, stretching, and/or compression can be used. The drawing, stretching, and/or compression are integrated into the die forming process to achieve desirable features (offsets, sealed corners, etc.). As can be seen in FIG. 10, an enclosure 300 can include a first side 310 including a flange 312. The enclosure 300 in this example was manufactured with press brake bending and spot welding (e.g., where hermetic sealing is not required). When using this type of process, open corners may occur. The manufacturing process according to the present disclosure eliminates the open corners.

The enclosure 300 includes a second side 313 including a strengthening bead 318 (e.g., extending inwardly or outwardly) and a flange 314. The enclosure 300 includes a third side 320 including a flange 322. The enclosure 300 includes a fourth side 324 including a strengthening bead 326. The flange 314 of the second side 313 is connected to the fourth side 324. The flange 312 of the first side 310 is joined to the third side 320. However, holes 340 may remain after folding and joining. Since a hermetic seal is desired, the holes 340 are filled using excess material on the 2D blank.

In some examples, the 2D blank is designed with excess material at corner cuts, along the side surfaces, and/or in other locations to eliminate bend reliefs/small holes at the corners that are typical in a press brake bending designs. In FIGS. 11 and 12, a 2D blank 350 includes first sides 360, second sides 364, and a bottom 366. The 2D blank 350 includes extra material 370 such as a radiused corner and/or other locations such as edges include a projection 372 to fill gaps and prevent holes after folding and joining. The extra material 370 can be compressed or stretched in a die bending/folding process.

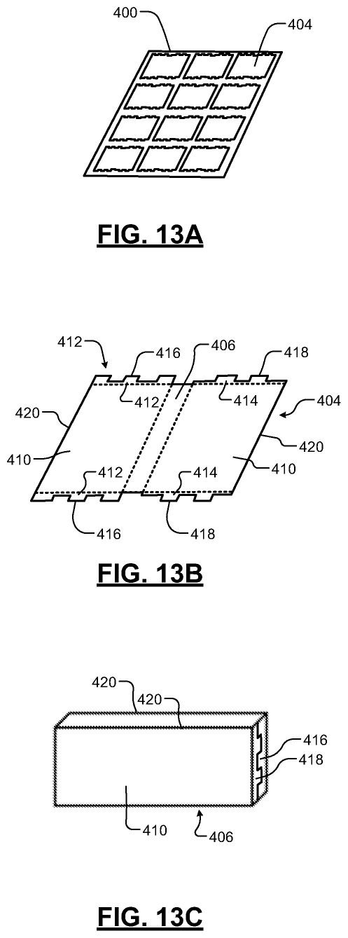

In other examples, additional steps are used during manufacturing. In this example, the manufacturing method includes 2D blank design, 2D blanking, die bending/folding, ironing and solid-state joining, and optional trimming. In FIGS. 13A to 13C, 2D blanks 404 are laid out on a metal sheet 400. The 2D blanks 404 are removed as shown in FIG. 13B. In this example, the 2D blanks 404 include first sides 410, second sides 412 and 414, and a bottom surface 406. The second sides 412 and 414 include flanges 416 and 418, respectively, that include complementary shapes that fit together when folded (e.g., along dotted lines) and joined to form a joint or fused zone. As can be appreciated, the 2D blank can include a lid or a separate lid can be attached.

After folding/bending of the enclosure, ironing and in-line solid-state joining are performed to join at least some of the sides of the enclosure. During ironing, large contact pressure is applied between two surfaces to reshape sides of the enclosure. In some examples, the large pressure created by the ironing tools causes thinning of the materials of the sides leading to metal flow and coalescence and subsequent solid-state joining. In some examples, the tooling performing the ironing and/or the materials can also be heated to increase temperature and to facilitate metal flow and coalescence of the metal in the fused zone.

In some examples, the joining can be achieved through either butt joining or lap joining. If butt joining is used, sides of the metal 2D blank are within a predetermined gap of an adjacent side after bending/folding and prior to joining. If lap joining is used, sides of the metal 2D blank overlap by a predetermined overlap distance after bending/folding and prior to joining.

In some examples, a supplementary joining process (i.e., laser welding) can be used if the strength of a fused or joined zones (e.g., along the flanges 416 and 418) do not achieve design requirements after solid-state joining and/or if solid-state joining cannot be performed in a given location. The supplementary joining can be done with or without specially designed fixtures. In some examples, additional features (i.e., offsets) can be added during the last ironing step or post ironing. In FIG. 13E, a trimming operation is optionally performed to remove uneven edges or other material after ironing.

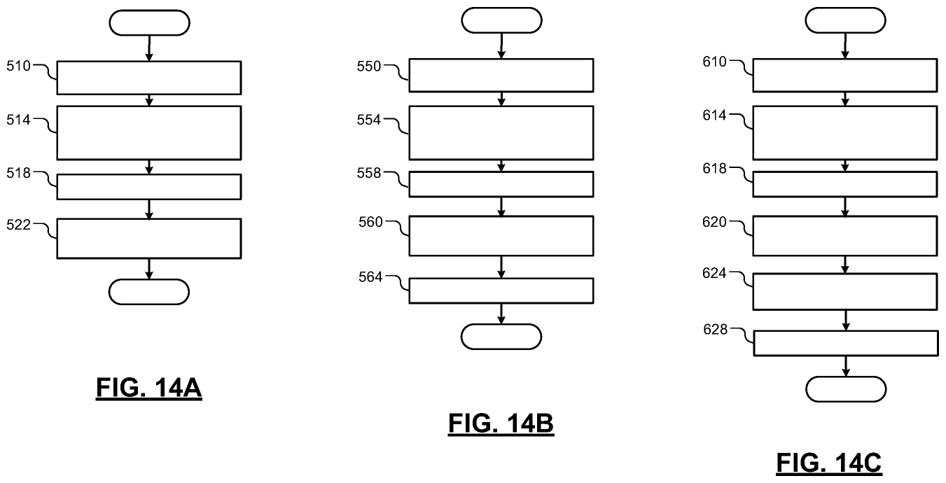

Referring now to FIGS. 14A to 14C, examples of methods for manufacturing an enclosure for a battery cell are shown. In FIG. 14A, 2D blanks are designed for a 3D enclosure at 510. The 2D blanks are arranged on a metal sheet. In some examples, the metal sheet is coated with an insulating layer. In this example, the 2D blanks include an enclosure body and a lid. At 514, the 2D blanks are cut from the metal sheet. At 518, the 2D blanks are bent and/or folded with a punch into a die to form an enclosure body. At 522, the enclosure body and lid are arranged in a fixture and joined (e.g., using laser welding or another approach).

In FIG. 14B, 2D blanks are designed for a 3D enclosure at 550. The 2D blanks are arranged on a metal sheet. In some examples, the metal sheet is coated with an insulating layer. In this example, the 2D blanks include an enclosure body and the lid is a separate component. The 2D blanks and the lid can be arranged on the same metal sheet or on different metal sheets. At 554, the 2D blanks and the lid are cut from the metal sheet(s). At 558, the 2D blanks corresponding to the enclosure body are bent and/or folded with a punch into a die to form the enclosure body. At 560, the enclosure body is joined. At 564, the enclosure body and lid are joined (e.g., using laser welding or another approach).

In FIG. 14C, 2D blanks are designed for a 3D enclosure at 610. The 2D blanks are arranged on a metal sheet. In some examples, the metal sheet is coated with an insulating layer. In this example, the 2D blanks include an enclosure body and are designed for subsequent ironing and solid-state joining. At 614, the 2D blanks are cut from the metal sheet. At 618, the 2D blanks are bent and/or folded into an enclosure body through 1-step die bending. At 620, ironing and solid-state joining are used to form the enclosure. At 624, trimming of edges is optionally performed to remove excess material. At 628, the enclosure body and lid are joined (e.g., using laser welding or another approach).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an enclosure, comprising:
designing a two dimensional (2D) blank corresponding to a three dimensional (3D) enclosure body;
laying out N of the 2D blanks on a metal sheet, where N is an integer greater than one;
separating the N 2D blanks from the metal sheet;
at least one of bending, folding, and flanging of one or more sides of the N 2D blanks into the 3D enclosure body; and
joining a plurality of sides of the 3D enclosure body.

2. The method of claim 1, further comprising coating the metal sheet with an insulating layer.

3. The method of claim 2, wherein the N 2D blanks further include a lid and further comprising:
arranging a battery cell stack in the 3D enclosure body; and
folding the lid to cover an opening of the 3D enclosure body and joining at least one edge of the lid to an opening in the 3D enclosure body.

4. The method of claim 3, wherein the lid includes at least one of a first opening for a terminal and a second opening for a vent.

5. The method of claim 1, further comprising:
after joining the plurality of sides of the 3D enclosure body, arranging a battery cell stack in the 3D enclosure body; and
joining a lid to an opening of the 3D enclosure body.

6. The method of claim 5, wherein the lid is joined to the 3D enclosure body using at least one of laser welding, crimping, and brazing using a braze wire.

7. The method of claim 1, wherein at least one of the plurality of sides of the 3D enclosure body is ironed and solid-state joined.

8. The method of claim 7, wherein at least one of the plurality of sides of the 3D enclosure body is laser welded.

9. The method of claim 1, wherein at least one of the plurality of sides of the 3D enclosure body is joined using at least one of laser welding, electron beam welding, brazing with a braze wire, and induction welding.

10. The method of claim 1, wherein at least one of the N 2D blanks includes first and second complementary flange portions that align, mate and are joined after the at least one of bending and forming.

11. The method of claim 1, wherein at least one of the N 2D blanks includes a corner that is radiused to prevent holes after folding and joining.

12. The method of claim 1, wherein at least one of the N 2D blanks includes side portions that include a projection to prevent holes after folding and joining.

13. The method of claim 1, wherein the metal sheet is made of a material selected from a group consisting of steel, stainless steel, and aluminum.

14. A method for manufacturing an enclosure, comprising:
providing a two dimensional (2D) blank corresponding to a three dimensional (3D) enclosure body and a lid at least partially attached to the 3D enclosure body;
at least one of bending, folding, and flanging one or more sides of the 2D blank into the 3D enclosure body;
joining two or more sides of the 3D enclosure body;
arranging a battery cell stack in the 3D enclosure body; and
joining at least one side of the lid to the 3D enclosure body.

15. The method of claim 14, wherein the 2D blank includes an insulating layer.

16. The method of claim 14, wherein:
the lid includes at least one of a first opening for a terminal and a second opening for a vent, and
at least one edge of the lid is joined to the 3D enclosure body using at least one of laser welding, crimping, and brazing using a braze wire.

17. The method of claim 14, wherein the 2D blank is made of a material selected from a group consisting of steel, stainless steel, and aluminum.

18. A method for manufacturing an enclosure, comprising:
providing a two dimensional (2D) blank corresponding to a three dimensional (3D) enclosure body;
at least one of bending, folding, and flanging of the 2D blank into the 3D enclosure body;
joining edges of the 3D enclosure body using ironing and solid-state joining;
arranging a battery cell stack in the 3D enclosure body; and
joining a lid to the 3D enclosure body.

19. The method of claim 18, wherein:
the lid includes at least one of a first opening for a terminal and a second opening for a vent, and
at least one edge of the lid is joined to the 3D enclosure body using at least one of laser welding, crimping, and brazing using a braze wire.

20. The method of claim 18, wherein:
the 2D blank is made of a material selected from a group consisting of steel, stainless steel, and aluminum and
the 2D blank includes an insulating layer.
